(19) United States
(12) Patent Application Publication
(10) Pub. No.: US 2016/0082441 A1
(43) Pub. Date: Mar. 24, 2016

(54) METHOD AND DEVICE FOR COMMINUTING

(71) Applicant: MAYFAIR VERMÖGENSVERWALTUNGS SE, Hamburg (DE)

(72) Inventors: Rony CALLENS, Niort (FR); Eric SCHROEDER, Athus (BE); Jeroen NIJSSE, Hoedekenskerke (NL)

(21) Appl. No.: 14/783,583

(22) PCT Filed: Apr. 3, 2014
(86) PCT No.: PCT/EP2014/056639

§ 371 Date: Oct. 9, 2015

(30) Foreign Application Priority Data
Apr. 10, 2013 (DE) 10 2013 206 275.3

(51) Int. Cl. B02C 13/20; B02C 13/28

(52) U.S. Cl. CPC B02C 13/205; B02C 13/28

(57) ABSTRACT

The invention relates to a method and a device for comminuting a light-weight, dry, fiber-containing material, in particular straw.

The invention relates to a method and to a device for comminuting a light-weight, dry, fiber-containing material, in particular straw.

Methods and devices for processing a light-weight, dry, fiber-containing material are used for comminuting annual plants, for example.

A light-weight, dry, fiber-containing material can in part contain extra long, thin components or, like straw, for example, it can comprise primarily extra long, thin components such as culms and stems, for example, or consist thereof.

Straw is understood to mean substantially threshed, dry culms, stems and leaves of cereals, oleiferous plants, fiber plants or legumes which are usually brittle, that is to say breakable.

A light-weight, dry, fiber-containing material comprises a plurality of individual particles, that is to say small particles that form the material overall. Therefore, for example, a particle of the straw material can be either a whole plant kept in one piece or also a chipped off or separated part of a plant. Additives or soiling substances such as soil, stones or the like are not included among the above-mentioned particles.

The particle size of a particle is reduced by comminution. Particle size is understood to mean an extent in different directions such as width, length or diameter, for example. Thus, for example, a reduction of only particle width by a comminution process can be referred to as a reduction of the particle size.

In the panel industry, for further processing OSSB panels (oriented structural straw board) or decorative panels, for example, it is not only necessary to randomly reduce the particle size, but the fiber-containing particles also need to be split or disaggregate in the fiber direction or parallel to the fiber. Thus, for example, a straw stem can be split by comminution into at least two half shells. Such a splitting improves the adhesion of glue, reduces air inclusions and improves the mechanical properties of the boards produced later.

The quotient of the number of particles split by comminuting divided by the number of particles before the comminution of the material is referred to as the splitting rate. This parameter gives information on how many particles, expressed as a percentage, were split by a comminution process. The degree of disaggregation is another parameter.

Furthermore, certain higher-quality final products such as, for example, decorative panels for exterior walls of houses, interior walls, ceilings or floors, require a certain length or minimum length of the particles. Long particles allow a targeted orientation of the particles of a material, which allows not only particularly good mechanical properties, but also surface structures with higher visual quality.

Particle length, in contrast to particle size, is understood to refer only to the extent of a particle in the fiber direction or in the longitudinal direction, that is to say the direction with the largest extent.

When using conventional devices for comminuting a fiber-containing material, as described in published document DE 41 01 352 C1, considerable problems occur on a regular basis if the material contains extra long, thin components, that is to say strand- or band-shaped approved portions.

These problems include, among others, blockage, frequent stopping of the machines to remove blockages, and reduced throughput quantity.

Additional, expensive measures are then needed, in order to be able to further process material nevertheless, to the extent that this is possible at all. A targeted influencing or controlling of the degree of disaggregation to be achieved is then also possible only to a very limited extent.

For the purpose of overcoming these problems, published document DE 41 01 352 C1 discloses a double-stream impact mill, which, for processing fiber-containing substances, provides an interruption of the impact tools in the peripheral outlet area of an annular disk-shaped guide channel. A free passage for approved products leading to the milling path can be created thus and accumulations of approved products can be reduced. A scattering disk protruding into the annular disk-shaped guide channel imparts additional tangential motion pulses to the approved portions, as a result of which they are projected in a targeted manner in the area of the milling path. The degree of disaggregation, the particle size and the separation sharpness can be influenced by influenced the annular sifting chambers, which are formed by adjustable retention rings adjoining the front sides of the milling path on both sides. A smaller particle size or a higher separation sharpness can thus be achieved, for example, by the positioning a second retention ring with retention margin h′ against a first retention ring with lower retention margin h. A device for the targeted influencing of the particle length is not provided in the disclosed impact mill.

The invention is based on the problem of providing a further developed method in addition to a device for comminuting a light-weight, dry, fiber-containing material, in particular straw.

For the solution of the problem, a method is used according to claim 1 and a device according to the independent claim. Advantageous designs are described in the dependent claims.

The problem is solved by a method for comminuting a light-weight, dry, fiber-containing material, in particular straw. The method provides that, by adjusting a gap a—in other words the gap width a—between an impact ledge and an impact edge of a device for comminuting a light-weight, dry, fiber-containing material, the particle length of the comminuted material is influenced in a targeted manner.

Comminuted material is understood to mean the material after the comminution has occurred. A targeted influencing of the particle length means that the comminuted material comprises particles with an average particle length or particle length distribution that is within a desired specified value range.

As a result of the targeted influencing of the particle length by adjusting the gap a, a light-weight, dry, fiber-containing material, such as straw, for example, can be further processed with particularly low expenditure for high-quality final products, for example, decorative panels or particle board that remain visible later, for the interior finish of buildings. Furthermore, as a result of the adjustment of the gap a and the particle length that as a result can be influenced in a targeted manner or substantially controlled, a particularly wide variety of potential final products results from the further processing of the comminuted material.

In an embodiment of the invention, the comminuted material has a splitting rate of at least 60%, preferably at least 75%, particularly preferably at least 90%, by comminuting, with at least one impact ledge and at least one impact edge of the comminuting device, a precomminuted material, wherein the material is precomminuted using, in particular, a star wheel of the comminuting device.

As a result of the possibility of producing by the method according to the invention split particles having a certain particle length, a particularly wide variety of potential final products becomes possible by further processing of the comminuted material.

An additional aspect of the invention relates to a device for comminuting a light-weight, dry, fiber-containing material, in particular straw, with a material feed area, an impeller and a material discharge area for the comminuted material, which can be used, in particular, for carrying out a method according to the above description. The device comprises a star wheel for the precomminution of the material and for the projection, that is for the generation of additional motion pulses, of the precomminuted material towards the impeller. The star wheel comprises at least one cutting edge, which is preferably oriented radially. It is preferable to provide four cutting edges.

Using the star wheel with at least one cutting edge for precomminuting the material, it is possible, in particular, prevent extra long particles from becoming wound around the rotating components of the device which thus leads to logjams and blockages which can be eliminated only at great expense. A low repair expenditure and a particularly high material throughput can thus be achieved. A radial orientation of the cutting edges as well as the provision of four cutting edges here have been found to be particularly effective for preventing blockages. In addition, the star wheel ensures an even distribution in the axial direction of the precomminuted material in the impeller, as a result of which the impeller can be exposed to particularly low wear during operation. Finally, the star wheel according to the invention already makes it possible for the device to achieve a particularly high splitting rate with the joint use of the star wheel and the impeller for comminuting the material.

In an embodiment, the impeller comprises at least one impact ledge for comminuting and conveying, that is to say radially guiding and transporting, the precomminuted material. By using one or more simple cutting ledges that are substantially not particularly sharp, that is to say not a blade or cutting edge, a device can be produced and operated at a particularly low manufacturing and maintenance cost.

Tests have shown surprisingly that by using the device with a star wheel and an impeller, which comprises at least one impact ledge, with the use of operating parameters that are still in the conventional operating range, a splitting rate of at least 50%, preferably at least 65%, particularly preferably at least 80% can be achieved, without having to provide an additional comminution tool. If the above-mentioned splitting rate is sufficient for later use, then, as a result of the fact that only the star wheel and the impeller are needed for the comminution, additional cutting or impact tools, for example, an impact ring, and the high maintenance cost associated therewith can be avoided.

In an embodiment, the invention comprises, in addition, an impact ring with at least one impact edge for comminuting the precomminuted material, optionally with fewer impact edges of the impact ring than impact ledges of the impeller. Precomminuted material here is understood to mean the material in the state that it is in after the precomminution by the star wheel and an additional comminution by the impeller. By additionally providing an impact ring, a targeted influencing of the particle length of the comminuted material as well as, due to a higher splitting rate, a particularly wide variety of potential end products becomes possible by further processing of the comminuted material. Furthermore, by means of a device with fewer impact edges of the impact ring than impact ledges of the impeller, a particularly low manufacturing and maintenance cost can be made possible.

Tests have shown that, by means of the device with a star wheel, an impeller with at least one impact ledge, and an impact ring with at least one impact edge—even if there are fewer impact edges than impact ledges—using operating parameters that are still in the conventional operating range, a splitting rate of the comminuted material of at least 60%, preferably at least 75%, particularly preferably at least 90% can be achieved.

Due to the use of at least one simple, substantially not particularly sharp impact edge, as can be implemented for example by a protrusion or a ledge, a savings in terms of blades or cutting edges on the impact ring becomes possible. If edges or impact edges were used, then the procurement of new edges or cutting edges, and the replacement, cleaning and grinding that may be required as frequently as every 4 hours, alone usually account for up to two thirds of the manufacturing and maintenance costs. By providing an impact ring with at least one impact edge, a comminuted material of comparable quality, that is to say splitting rate, particle length and proportion of approved fine products, can be achieved, but at particularly low manufacturing and maintenance cost.

In an embodiment, an adjustable gap a or gap width a is provided between the impact edge of the impact ring and an impact ledge of the impeller. By adjusting the gap a, the targeted influencing of the particle length of the comminuted material, as well as further processing to a wide variety of final products, in particular high-quality final products can thus be made possible.

In an embodiment, a lower delimitation of the gap a is provided, preferably an abutment, which delimits the gap a to a gap width of preferably at least 1.5 mm, preferably at least 3 mm, particularly preferably at least 5 mm. By providing such a minimum gap width, a particularly small proportion of approved fine products can be achieved and thus a higher-quality comminuted material can be produced.

In an embodiment, the impact ring rotates counter-currently relative to the impeller, or does not rotate at all, or rotates cocurrently with lower rpm, wherein a difference in rpm of preferably at least 800 rpm, preferably at least 900 rpm, particularly preferably at least 1000 rpm can be provided. By providing such a difference in rpm by means of an impact ring that rotates counter-currently relative to the impeller, or not at all, or cocurrently with lower rpm, an additional comminution and splitting becomes possible.

In an embodiment, the star wheel, the impeller and the impact ring are provided in such a way that, without an additional comminution tool, a splitting rate of at least 60%, preferably at least 75%, particularly preferably at least 90% can be achieved. A comminuted material with particularly high quality can thus be produced.

In an embodiment, the star wheel and/or the impact ring are mounted on the same axle of the impeller, in particular using a hollow axle. By suspending the star wheel and/or the impact ring on the same axle of the impeller, a device with particularly few parts and a small installation space can be produced. By means of a hollow axis, a rotation with different speed of rotation that is counter-current or cocurrent relative to the impeller can be made possible, in order to make possible both higher relative speeds between impeller and impact ring in the case of counter-current rotation and also, in particular, little blockage due to the rotational movement itself.

In an embodiment, the star wheel is arranged in the material flow in or adjacent to the material feed area. A particularly effective and high material throughflow can thus be achieved.

In an embodiment, several star wheels are provided, which are arranged in particular angularly offset and/or axially separated, preferably with increasing diameter in the material flow direction. By means of several star wheels which are arranged in particular with axial separation with increasing diameter and with angular offset, the device can be operated with a particularly high material throughflow speed, or, in particular, extra long, thin components can also be processed.

In an embodiment, one or more impact ledges and/or impact edges can be arranged radially or in a certain angular position, that is they can be attached in an adjustable angular position. By a radial arrangement or an arrangement that is angled toward or away in the rotation direction, one or more impact ledges and/or impact edges, the splitting rate and the approved fine products proportion can be influenced in a targeted manner. Furthermore, the flexibility of the arrangement and adjustability of the angular position of impact ledges and/or impact edges make possible both positive and also negative shearing effects for a higher comminution performance or, on the other hand, a processing that is particularly gentle on the fibers.

In an embodiment, at least one impact ledge and/or impact edge comprise(s) an exchangeable wear plate for the comminution and conveyance of the precomminuted material, with a thickness of the wear plates of advantageously at least 6 mm, preferably at least 8 mm, particularly preferably at least 10 mm and advantageously at most 20 mm, preferably at most 17 mm, even more preferably at most 14 mm. By providing wear plates, an operation with particularly low maintenance cost can become possible. Due to the low weight of the particles of the light-weight, dry, fiber-containing material to be processed, comparatively thin wear plates can be used and thus material can be saved.

In an embodiment, at least one impact ledge and/or impact edge comprise(s) an exchangeable support plate for reinforcing a wear plate. By providing a support plate for reinforcing a wear plate, bending of the wear plate is counteracted. A particularly long useful life of the wear plate can thus be achieved.

In an embodiment, at least one impact ledge and/or impact edge comprise(s) a carrier for attaching a support plate or a wear plate, particularly with an attachment device for adjusting and attaching the carrier on the impeller or the impact ring in a certain angular position. By means of such a carrier, a particularly simple exchange of the support plate or wear plate can be made possible. The advantageously provided attachment device allows both positive and also negative shearing effects for a higher comminution performance, or, on the other hand, a processing that is particularly gentle on the fibers.

In an embodiment, a stop device for adjusting and holding the support plate and/or wear plate on the carrier is provided. In particular, it comprises an oblong hole and/or a screw connection. Adjusting here is understood to mean in particular the adjusting of the gap a for the targeted influencing of the particle length. By means of such a stop device, a particularly simple adjustment of the gap a for the targeted influencing of the particle length is possible. Using a screw connection, adjusting and holding can be implemented particularly simply. In particular, on the carrier-side, an oblong hole can be converted with particularly low expenditure, in order not only to allow adjusting and holding, but also to provide a stop for producing a minimum gap width.

In an embodiment, impeller and/or impact ring comprise one or more adjustable abutments and/or markings, in particular scales, for adjusting the gap a. Preferably engraving, laser engraving, drilling, notching or printing is used for the marking. By marking or by means of an adjustable abutment, after the exchange, a wear plate can be brought particularly simply and rapidly back into the correct position in accordance with the desired gap width a and attached there. A change of the adjustment of the gap a is thus also possible at particularly low expenditure.

In an embodiment, the device comprises a suction unit, which conveys or suctions the light-weight, dry, fiber-containing material, from the material feed area, through the shearing area, to the material discharge area and regularly from there to a collection container for the comminuted final material, where it can be removed later. By means of such a suction unit, a particularly high material throughflow is made possible and blockage of the device is counteracted.

The present invention comprises, in particular, the designs known from European Patent 12177485.5, for solving the technical problems mentioned in this patent application. We include the disclosure content of this application in the present application. In particular, the design of the present invention therefore additionally comprises the following:

In an embodiment, the device for comminuting material, in particular, a light-weight material, preferably raw material for panels, comprises a material feed unit, a comminution unit and a suction unit for suctioning a material, in particular a light-weight material, through the comminution unit.

In an embodiment, the device comprises a gas source which is connected to an inlet of the comminution unit and/or to an outlet of the comminution unit.

In an embodiment, the device comprises one or more channels for guiding a gas flow and/or a material flow.

In an embodiment, the material feed unit is arranged above the comminution unit, preferably connected to a vertical part of a channel which leads to the inlet of the comminution unit, preferably with a connection in the form of a channel that is inclined downward.

In an embodiment, the device comprises a separation unit for separating heavy foreign materials in the material, preferably in the form of a branched off chamber, which preferably branches off in a curve and/or in the direction of gravitation from a channel for guiding a gas flow and a material flow to the inlet of the comminution unit.

In an embodiment, the device is provided in such a way that the cross section of the outlet of the comminution unit and/or the cross section of the channel connected to the outlet is smaller than the cross section of the inlet of the comminution unit and/or the cross section of the channel connected to the suction unit, wherein, preferably, the channel connected to the outlet is connected in the shape of a T, in particular with a channel from the gas source to the suction unit.

In an embodiment, the suction unit has a larger cross section than the inlet to the suction unit and/or a device for the separation of gas and material.

In an embodiment, the device comprises a distributor for distributing a gas flow into two or more separate gas flows, preferably through a swivelable flap, preferably within the gas flow, with an articulation, for example, which is arranged at the center of a Y-, T- or t-shaped fork.

In an embodiment, the gas source comprises a gas inlet with a grate or filter and/or an outlet with a distributor, preferably with a cross section of the outlet that is smaller in comparison to the inlet.

In an embodiment, the device for comminuting a material, in particular a light-weight material, preferably a raw material for panels, comprises a material feed unit, a comminution unit and a conditioning unit for treating material before and/or after comminution preferably with conditioned gas.

In an embodiment, the conditioning unit allows an adjustment of the gas temperature and/or an addition of additives to the gas, preferably liquids, other gases and/or powdered substances.

In an embodiment, the device comprises an injector for adding additives, preferably to gas, for example, within the gas source, which is preferably designed as a nozzle-shaped injector, preferably in the central area of a chamber or of a channel for guiding a gas flow and/or in the outlet direction of the chamber or of the channel.

In an embodiment, the device comprises an additive feed unit for providing additives for the injector, preferably in the shape of a funnel, arranged preferably above the injector and/or outside of the chamber or of the channel, and preferably connected with the injector by an L-shaped feed channel.

In an embodiment, the device comprises a heat exchanger for the cooling and/or heating of a gas, preferably directly in a chamber or channel for receiving or guiding a gas flow, preferably at the inlet of the gas source.

In an embodiment, the comminution unit comprises a blade ring and an impeller.

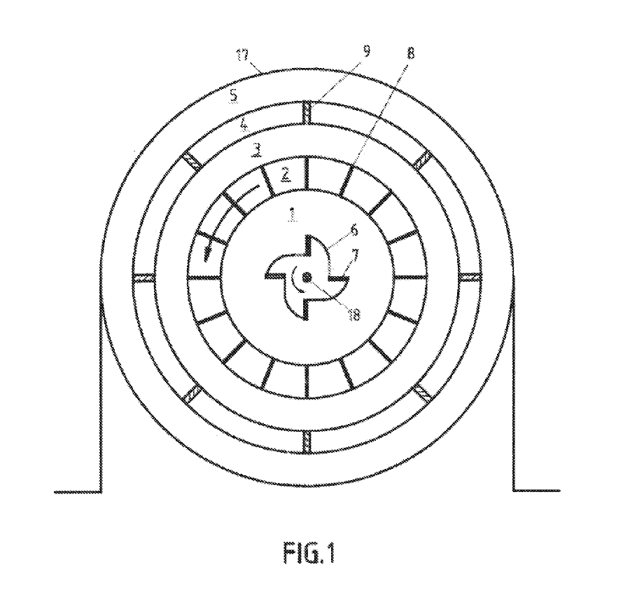

The invention is explained further in reference to the embodiment examples represented in FIGS. 1 to 3.

FIG. 1 shows: A diagrammatic representation of a comminuting device (cross-sectional representation in a front view).

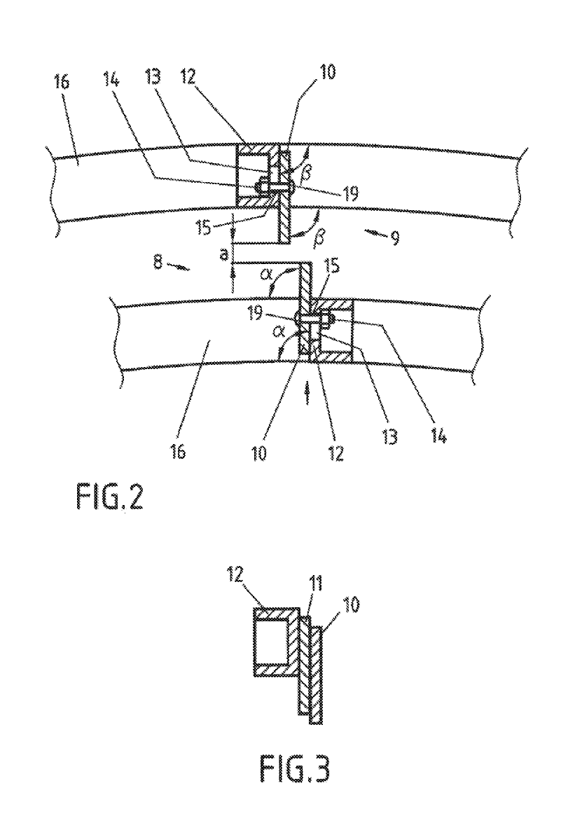

FIG. 2 shows: A diagrammatic representation, gap a (cross-sectional representation in a front view).

FIG. 3 shows: A diagrammatic representation of an impact edge or impact ledge with support plate (cross-sectional representation in a front view).

FIG. 1 shows a device for comminuting straw with a moisture content of typically 4% to 8%, a diameter of approximately 6 mm, and a length of approximately 300 mm to 400 mm.

Optionally, the straw can already be supplied with shortened length, in order to be able to process the material then more rapidly or with higher material throughput in the present device.

At the beginning of the process in the device, in the material feed area 1, the material or the straw axially strikes the star wheels 6 which are arranged at a distance apart of approximately 100 mm on the same axle 18 as the impeller 2, and which have diameters that increase in size in the material flow direction. The straw is precomminuted by radial cutting edges 7 of the star wheel 6. Blockages and jamming of the impeller due to longer material components wound around the axle can thus be prevented. The star wheels 6 are shaped so that the precomminuted straw is projected radially toward the impeller 2 and is in particular distributed evenly in the axial direction 18 so that the wear on the impeller 2 can be reduced overall.

When the precomminuted straw strikes the radially arranged impact ledges 8 of the rapidly rotating impeller 2 with a circumference typically of approximately 1200 mm to 1600 mm, strong, energy-rich shearing, bumping, friction, pressure, bending and impact forces act on the straw particles. The resulting comminution effects comprise, in particular, a fiber-parallel splitting of the particles with splitting rates from 80% to 85%. This results in slivers or small fine shavings with substantially maintained fiber structure, which are radially conveyed further by centrifugal force along the impact ledges 8 of the impeller 2.

If the straw is to be processed further later to form decorative panels as final product, then not only is a higher splitting rate of more than 90% to 95% necessary, but, in addition, a particularly large particle length of the comminuted straw of at least 90 mm to 100 mm is necessary.

Such high demands on the quality of the comminuted straw can be satisfied by the device represented in FIGS. 1 and 2 by the optional additional installation of an impact ring 4.

The impact ring 4 also turns about the same axle 18 as the impeller 2 and the star wheels 6. The use of a hollow axle makes it possible to rotate the impact ring 4 counter-currently relative to the impeller. The speed of rotation of the impact ring 4 is very low, for example, less than 100 rpm, in comparison to the impeller which regularly has a speed of rotation of more than 1000 rpm.

Similarly to the impact ledges 8 of the impeller 2, the impact ring 4 comprises impact edges 9. The precomminuted straw, which is moved by centrifugal force radially along the impact ledges 8 of the impeller 2, by inertia continues with the rotational movement of the impeller even after leaving the impact ledges 8 in the shearing region 3. There, the precomminuted straw strikes the impact ledges 8, as a result of which the above described comminution effects occur again. A particularly high splitting rate of more than 90% to 95% can thus be achieved. The comminuted material finally migrates due to centrifugal force along the impact edges 9 in the material discharge area 5 in the vicinity of the housing 17.

In straw, in general, the distance between nodes in the culms is approximately 120 mm. Such a node has a particularly high strength in comparison to the culm and can therefore be split only with greater effort. A device that provides only a star wheel 6 and an impeller 2 for the comminution can split these nodes only to a small extent. Due to the additional installation of an impact ring 4, by comparison therewith, a larger proportion of split nodes can be achieved. The proportion of the split nodes as a rule is lower than the above-mentioned splitting rates of the material due to the comminution.

The impact ledges 8 of the impeller 2 and the impact edges 9 of the impact ring 4 have a similar structure. Between a front ring and a back ring 16, carriers 12 are attached. The carriers 12 are oriented substantially radially. However, different angular positions α, β of the carriers 12 are possible. The carriers 12 are used as seating for wear plates 10 which basically form the impact ledges 8 or impact edges 9 and are in direct contact with the material.

The wear plates 10 have one or more holes 19 for attachment by means of screw connections 14. In this manner, an easy exchange of the wear plates 10 becomes possible. In addition, the supports have an oblong hole 13 which allows attachment of the wear plate 10 in different radial positions. A typical adjustment range is 0 mm to 50 mm for both the impeller 2 and also the impact ring 4.

Between the carrier 12 and the wear plate 10, in order to support the wear plate 10, an additional exchangeable support plate 11 is provided, which is arranged between the carrier 12 and the wear plate 10 (FIG. 3).

Between the wear plates 10 of the impeller 2 and of the impact ring 4, a gap a is formed. The oblong holes 13 are arranged so that the gap a typically can assume values between 5 mm and 105 mm. Due to the abutment 15, an adjustment of a lower gap width a is not possible.

By adjusting the gap a, the straw length after comminution can be influenced in a targeted manner. A targeted comminution of the straw with particularly large particle lengths of more than 50 mm on the average or an average particle length in the range of approximately 90 mm to 100 mm can thus be achieved by the present device. A processing of straw for later further processing to high-quality final products, such as decorative panels, thus becomes possible.

In particular, a light-weight, dry, fiber-containing material includes reeds or Phragmites.

In particular, a light-weight, dry, fiber-containing material includes culms, stems or fibers from sweet grasses such as rice or rice straw, corn, wheat, barley, millet, oat, rye or cattail.

In particular, a light-weight, dry, fiber-containing material includes jute, hemp, flax, kenaf, palm branches or sisal.

In particular, a light-weight, dry, fiber-containing material includes material from coconut, soybeans, bamboo, peanut shells, light-weight woods, kapok trees or cotton plants or wool.

In particular, a light-weight, dry, fiber-containing material includes textile waste, plant waste, paper waste or other light-weight, dry, fiber-containing waste products.

In particular, in the above description and in the claims, the term “straw” also includes other lignocellulose materials, preferably those having a straw-like structure such as reeds, rice straw or bamboo, for example.

What is claimed is:

1-15. (canceled)

16. A device for comminuting a light-weight, dry, fiber-containing material, in particular straw, with a gap between an impact ledge of an impeller and an impact edge of an impact ring, wherein the device for comminuting a light-weight, dry, fiber-containing material is provided in such a way that, by adjusting a gap, the particle length of the comminuted material can be influenced in a targeted manner, wherein particle length, in contrast to a particle size, refers only to the extent of a particle in the fiber direction or in the longitudinal direction.

17. The device according to claim 16, in which the gap can be adjusted with gap widths between 5 mm and 105 mm.

18. The device according to claim 16, which is provided in such a way that the device can comminute a light-weight, dry, fiber-containing material with a splitting rate of at least 60%, preferably at least 75%, particularly preferably at least 90%, wherein the splitting rate corresponds to a quotient of a number of particles split by the comminution divided by the number of particles before the comminution of the material, wherein split particles refer in particular to particles split in the fiber direction or parallel to the fiber.

19. The device according to claim 16, which is provided in such a way that the device is capable of comminuting a light-weight, dry, fiber-containing material so that on average a particle length of the comminuted material of more than 50 mm or in the range from approximately 90 mm to 100 mm can be obtained.

20. The device according to claim 16, which is provided in such a way that the device can split nodes in straw.

21. The device according to claim 16, characterized in that the impact ring can rotate counter-currently relative to the impeller, or not at all, or cocurrently with lower rpm.

22. The device according to claim 16, characterized by a lower delimitation of the gap, preferably abutment, which can delimit the gap to a gap width of advantageously at least 1.5 mm, preferably at least 3 mm, particularly preferably at least 5 mm.

23. The device according to claim 16, characterized in that one or more impact ledges are arranged on an impeller and/or one or more impact edges are arranged on an impact ring in a certain angular position.

24. The device according to claim 16, characterized by at least one impact ledge and/or at least one impact edge with an exchangeable wear plate for comminuting and conveying the precomminuted material.

25. The device according to claim 16, characterized by at least one impact ledge and/or at least one impact edge with an exchangeable support plate for reinforcing the wear plate.

26. The device according to claim 16, characterized by at least one impact ledge and/or at least one impact edge with a carrier for the attachment of a support plate or a wear plate, preferably with an attachment means for attaching the carrier in a certain angular position.

27. The device according to claim 16, characterized by a stop device for adjusting and holding a support plate and/or wear plate on a carrier, including in particular an oblong hole and/or a screw connection.

28. The device according to claim 16, characterized by a suction unit which is provided in such a way that the light-weight, dry, fiber-containing material can be suctioned from a material feed area through a shearing area into a material discharge area.

29. A device for comminuting a light-weight, dry, fiber-containing material, in particular straw, with a material feed area, an impeller and a material discharge area for the comminuted material, characterized by a star wheel with at least one cutting edge for precomminuting the material and for projecting the precomminuted material towards the impeller.

30. The device according to claim 29, characterized by at least one impact ledge of the impeller for comminuting and conveying the precomminuted material.

31. The device according to claim 30, characterized by an impact ring with at least one impact edge for comminuting the precomminuted material.

32. The device according to claim 31, characterized in that a gap between an impact ledge of the impeller and an impact edge of an impact ring can be adjusted.

33. The device according to claim 32, characterized in that, by adjusting the gap between the impact ledge and the impact edge, a particle length of the comminuted material can be influenced in a targeted manner, wherein particle length, in contrast to a particle size, refers only to the extent of a particle in the fiber direction or in the longitudinal direction.

34. A method for comminuting a light-weight, dry, fiber-containing material, in particular straw, characterized in that, by adjusting a gap between an impact ledge and an impact edge of a device for comminuting a light-weight, dry, fiber-containing material, a particle length of the comminuted material can be influenced in a targeted manner.

35. The method according to claim 34, characterized in that a splitting rate of at least 60%, preferably at least 75%, particularly preferably at least 90% is achieved by comminuting precomminuted material using at least one impact ledge and at least one impact edge of the comminution device, wherein the material is precomminuted in particular using a star wheel.
